(19) United States
(12) Patent Application Publication
(10) Pub. No.: US 2025/0144760 A1
(43) Pub. Date: May 8, 2025

(54) MICROSWITCH AUTOMATIC ASSEMBLY APPARATUS, MICROSWITCH, AND ASSEMBLY METHOD

(71) Applicant: SHENZHEN GANGYUAN MICOKEY TECHNOLOGY CO., LTD., SHENZHEN (CN)

(72) Inventors: Delian WU, Shenzhen (CN); Zhimin HU, Shenzhen (CN); Liming SHENG, Shenzhen (CN)

(21) Appl. No.: 18/425,233

(22) Filed: Jan. 29, 2024

(30) Foreign Application Priority Data
Nov. 7, 2023 (CN) 202311468539.5

(51) Int. Cl. B23Q 7/02; B23Q 11/00; B23Q 11/10; H01H 3/02; H01H 3/32

(52) U.S. Cl. CPC B23Q 7/02; B23Q 11/0046; B23Q 11/005; B23Q 11/10; H01H 3/02; H01H 3/32

(57) ABSTRACT

The present application discloses a microswitch automatic assembly apparatus, microswitch, and assembly method, the microswitch automatic assembly apparatus comprises a base, a material carrying rotary table and an installation disc that are provided on the base, a base loading mechanism, a support installation mechanism, a swing rod installation mechanism, and a tension spring installation mechanism are sequentially provided along a rotation direction of the material carrying rotary table, the tension spring installation mechanism comprises a tension spring pre-installation platform, a tension spring position detection platform, a tension spring installation platform, and a tension spring elasticity detection platform.

### CROSS-REFERENCE TO RELATED APPLICATION

The present application claims the priority benefits of China patent application No. 202311468539.5, filed on Nov. 7, 2023. The entirety of China patent application No. 202311468539.5 is hereby incorporated by reference herein and made a part of this specification.

### TECHNICAL FIELD

The present application relates to a technical field of an automatic apparatus, and in particular, relates to a microswitch automatic assembly apparatus, microswitch, and assembly method.

### BACKGROUND ART

A microswitch is a type of switching element that applies external force to a transmission element (such as a pin, button, lever, roller, etc.), applying force to an action spring plate, when the action spring plate moves to a critical point, an instantaneous action is generated, causing a movable contact at an end of the action spring plate to quickly connect or disconnect from a fixed contact. Meanwhile, the microswitch plays an important role in an electronic device, controlling a connection and disconnection of a circuit, achieving signal transmission and device operation. However, due to a small size of the microswitch, which faces a challenge of a low yield rate during assembly and production, a main reason is that the small size of the microswitch requires higher precision and meticulous operation during assembly and installation, especially when installing a spring of the microswitch, it is easy to cause the low yield rate of the microswitch due to inaccurate spring engagement.

In prior art, the small size of the microswitch requires higher precision and meticulous operation during assembly and installation, an installation accuracy cannot be improved by moving a plurality of assembly cylinders, which causes the low yield rate of the microswitch.

In addition, in prior art, when installing the spring, adopting a mechanical arm device and a spring clamping hook apparatus to install once, which is easy to cause the low yield rate of the microswitch due to inaccurate spring engagement.

### SUMMARY

In order to overcome a technical problem of a low yield rate of a microswitch caused by inaccurate engagement of a tension spring during an installation of the microswitch, which requires higher precision and meticulous operation due to a small size of an assembly and installation process during a production and assembly of the microswitch, the present application provides a microswitch automatic assembly apparatus, microswitch, and assembly method.

In a first aspect, the microswitch automatic assembly apparatus provided in the present application adopts the following technical solution:
the microswitch automatic assembly apparatus comprising:
a base, the base is provided with a material carrying rotary table, and an installation disc is provided on the material carrying rotary table, a plurality of workpiece carriers are provided at equal intervals around the material carrying rotary table;
a base loading mechanism, the base loading mechanism is provide on the base, and the base loading mechanism comprises a base material reel, a first material channel, and a second material channel, wherein the second material channel is provide on a first side of the first material channel;
a support installation mechanism, the support installation mechanism is provided downstream of the base loading mechanism in a rotation direction of the material carrying rotary table, wherein the support installation mechanism comprises a support material tray that is provided on the base, a support material channel that is connected to the support material tray, and a support assembly mechanical arm;
a swing rod installation mechanism, the swing rod installation mechanism is provided downstream of the support installation mechanism in the rotation direction of the material carrying rotary table, wherein the swing rod installation mechanism comprises a swing rod material reel, a swing rod material channel, and a swing rod assembly mechanical arm; and
a tension spring installation mechanism, the tension spring installation mechanism is provided downstream of the swing rod installation mechanism in the rotation direction of the material carrying rotary table, wherein the tension spring installation mechanism comprises a tension spring pre-installation platform, a tension spring position detection platform, a tension spring installation platform, and a tension spring elasticity detection platform that are sequentially provided along the rotation direction of the material carrying rotary table.

By adopting the above technical solution, when installing the tension spring of the microswitch, a four step operation method is adopted, namely pre-installation, position detection, installation, and installation detection. After pre-installation, position detection is carried out to ensure an accuracy of a relative position between the tension spring and a switch base, improving an accuracy of installing the tension spring during the installation, and thereby increasing a yield rate of the microswitch in production.

Optionally, the tension spring pre-installation platform comprises a tension spring material tray that is provided on the installation disc, a tension spring material channel with one end connected to the tension spring material, a tension spring correction mechanical arm, and a tension spring pre-installation mechanical arm.

By adopting the above technical solution, with a vibration of the tension spring material tray, the tension spring in the tension spring material tray flows to the tension spring material channel, the tension spring correction mechanical arm grabs the tension spring on the tension spring material channel and corrects a direction of the tension spring, the tension spring pre-installation mechanical arm grabs the tension spring on the tension spring correction mechanical arm and pre installs it on the switch base, ensuring the accuracy of the relative position between the tension spring and the switch base.

Optionally, the tension spring position detection platform comprises a first support that is fixed on the installation disc and a position detector that is provided on the first support for detecting a position of a pre-installed tension spring; the tension spring installation platform comprises a second support that is fixed on the installation disc and a mechanical pulling claw that is connected to the second support and capable of moving up and down for stretching the tension spring; the tension spring elasticity detection platform comprises a third support that is fixed on the installation disc and a compression bar that is provided on the third support for detecting an installation position of the tension spring.

By adopting the above technical solution, the position detector detects the relative position between the pre-installed tension spring and the switch base, after ensuring the accuracy of the relative position, a tension spring mechanical arm for installing the tension spring on the tension spring installation platform accurately assembles the tension spring onto the base.

Optionally, a base detector, a base cutter, and a first transfer mechanical arm are sequentially provided above the first material channel, the base detector is configured to detect whether there is material on a base material belt and detect an appearance and a dimension of the base, the base cutter is configured to cut a base chain into a single base, and the first transfer mechanical arm is configured to transfer the base to the second material channel.

By adopting the above technical solution, the base detector detects the dimension and appearance of the base, ensuring that the bases transferred to the material carrying rotary table are all qualified, the base cutter cuts the base chain into the single base

Optionally, a blowing and suction device, an oil dispenser, and a second transfer mechanical arm are sequentially provided above the second material channel, the blowing and suction device is configured to remove impurities from the base, the oil dispenser is configured to apply oil to the base to improve a lubrication and corrosion resistance of a base surface, and the second transfer mechanical arm is configured to transfer the base to the workpiece carriers.

By adopting the above technical solution, the blowing and suction device can generate high-pressure airflow, which can remove impurities from the base of the microswitch, after oiling the base with the oil dispenser, which can improve the lubrication and corrosion resistance of a contact surface, thereby increasing a reliability and service life of the microswitch.

Optionally, the swing rod installation mechanism further comprises a swing rod cutter, a swing rod transfer mechanical arm, and a swing rod detector that are provided downstream of the swing rod material channel, the swing rod transfer mechanical arm is configured to transfer a swing rod on the swing rod material channel to the swing rod detector for the swing rod detector to detect opening and closing dimensions of the swing rod.

By adopting the above technical solution, the swing rod detector detects the dimension of the swing rod to ensure that the swing rod transferred to the material carrying rotary table is qualified.

Optionally, the swing rod installation mechanism further comprises a swing rod correction mechanical arm that is provided between the swing rod detector and the swing rod assembly mechanical arm for correcting a direction of the swing rod.

By adopting the above technical solution, the swing rod correction mechanical arm can adjust a position of the swing rod according to an angle required for assembly to meet the angle for installation.

Optionally, the microswitch automatic assembly apparatus further comprising an opening and closing dimensions detection platform, a material separation detection platform, and a material unloading channel, that are sequentially provided downstream of the tension spring elasticity detection platform along the rotation direction of the material carrying rotary table, the opening and closing dimensions detection platform is configured to detect opening and closing dimensions between contacts, and the material separation detection platform detects a performance of workpieces.

By adopting the above technical solution, detecting an assembled microswitch, an unqualified microswitch falls into a waste material channel, while a qualified microswitch flows to the material unloading channel, ensuring that all microswitches in the material unloading channel are good products.

In a second aspect, the microswitch provided in the present application adopts the following technical solution:
the microswitch, adopting the microswitch automatic assembly apparatus as described in any one of the above items, the microswitch comprises a microswitch base, an action spring plate assembly, and a silencing gasket, the silencing gasket is provided on an upper surface and a lower surface of the action spring plate assembly to eliminate a noise generated when the action spring plate assembly collides with an upper cover and the microswitch base.

By adopting the above technical solution, when the microswitch is turned on, the action spring plate assembly moves downwards, driving the silencing gasket to move downwards, causing the silencing gasket to collide with the base; when the microswitch is turned off, the action spring plate assembly moves upwards, driving the silencing gasket to move upwards, the silencing gasket collides with the upper cover, reducing the noise generated when the microswitch is turned on and turned off.

In a third aspect, the assembly method for the microswitch provided in the present application adopts the following technical solution:
the assembly method for the microswitch, adopting the microswitch automatic assembly apparatus as described in any one of the above items, the assembly method comprises:
S1. providing switch bases, the switch bases are provided on base frames, the base frames are connected to each other, and forming a base chain;
S2. transferring the base chain to the first material channel, and then transferring the base chain to the material carrying rotary table through the first material channel and the second material channel;
S3. when the material carrying rotary table transfers the base to the support installation mechanism, the support assembly mechanical arm grabs the support and installs it onto the base;
S4. when the material carrying rotary table transfers a base of an installed support to the swing rod installation mechanism, the swing rod assembly mechanical arm grabs the swing rod and installs it on the base;
S5. when the material carrying rotary table transfers a base of an installed swing rod to the tension spring installation mechanism, the tension spring installation mechanism performs a pre-installation, position detection, installation, and installation detection on the tension spring.

By adopting the above technical solution, when installing the tension spring of the microswitch, a four step operation method is adopted, namely pre-installation, position detection, installation, and installation detection. After pre-installation, position detection is carried out to ensure an accuracy of a relative position between the tension spring and a switch base, improving an accuracy of installing the tension spring during the installation, and thereby increasing a yield rate of the microswitch in production.

In summary, the present application includes at least one of the following beneficial technical effects:
1. when installing the tension spring of the microswitch, the four step operation method is adopted, namely pre-installation, position detection, installation, and installation detection. After pre-installation, position detection is carried out to ensure the accuracy of the relative position between the tension spring and the switch base, improving the accuracy of installing the tension spring during the installation, and thereby increasing the yield rate of the microswitch in production;
2. the microswitch automatic assembly apparatus detects the assembled microswitch, the unqualified microswitch falls into the waste material channel, while the qualified microswitch flows to the material unloading channel, ensuring that all microswitches in the material unloading channel are good products;
3. a material transferring mechanism of the microswitch automatic assembly apparatus adopts a circular design, which improves a space utilization rate of an apparatus.

### BRIEF DESCRIPTION OF THE DRAWINGS

FIG. 1 illustrates a three-dimensional schematic structure view of a microswitch automatic assembly apparatus of the present application;

FIG. 2 illustrates a tension spring installation mechanism schematic structural view of the microswitch automatic assembly apparatus of the present application;

FIG. 3 illustrates a base loading mechanism schematic structural view of the microswitch automatic assembly apparatus of the present application;

FIG. 4 illustrates a swing rod installation mechanism schematic structural view of the microswitch automatic assembly apparatus of the present application;

FIG. 5 illustrates a schematic structure view of the microswitch of the present application.

### DETAILED DESCRIPTION

The following will provide a clear and complete description of the technical solution in an embodiment of the present application, with reference to FIGS., obviously, the described embodiment is only a part of the embodiment of the present application, not an entire embodiment. Based on the embodiment in the present application, other embodiments obtained by those skilled in the art under a premise of understanding an invention concept of the present application are within a scope of protection of the present application.

It should be noted that if there is a directional indication (such as up, down, left, right, front, back . . . ) involved in the embodiment of the present application, the directional indication is only configured to explain a relative position relationship and motion situation between components in a specific posture (as shown in the figure), if the specific posture changes, the directional indication also changes accordingly.

In order to facilitate an understanding of the technical solution of the present application, the following will provide a further detailed description of a microswitch automatic assembly apparatus, microswitch, and microswitch assembly method of the present application, but it is not limited to a protection scope of the present application.

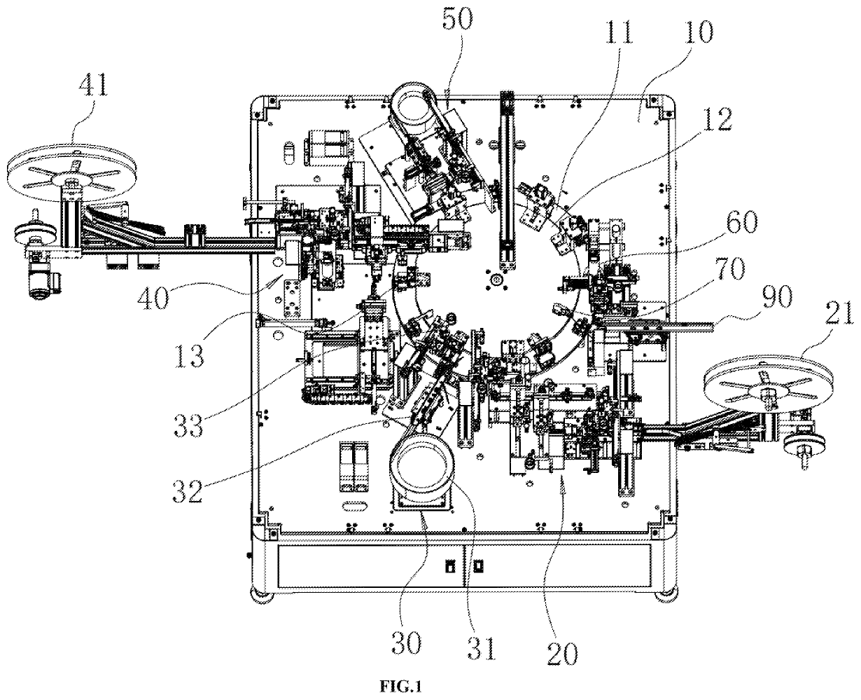

Referring to FIG. 1, the present embodiment provides the microswitch automatic assembly apparatus, including a base 10, a base loading mechanism 20, a support installation mechanism 30, a swing rod installation mechanism 40, and a tension spring installation mechanism 50. The base 10 is provided with a material carrying rotary table 11, and an installation disc 12 is provided on the material carrying rotary table 11, workpiece carriers 13 are provided at equal intervals around the material carrying rotary table 11. Centers of the material carrying rotary table 11 and the installation disc 12 are on a same vertical line, and a diameter of the material carrying rotary table 11 is greater than a diameter of the installation disc 12. The material carrying rotary table 11 can rotate along the vertical line where the centers are located, while the installation disc 12 cannot rotate. The base loading mechanism 20 is provide on the base 10, and the base loading mechanism 20 includes a base material reel 21, a first material channel 22, and a second material channel 23 which is provide on a side of the first material channel 22. The first material channel 22 and the second material channel 23 are provided with conveyor belts. The base material reel 21 has a first material reel supporting frame, and an end of a bottom frame of the first material reel supporting frame is fixed on the base 10. The support installation mechanism 30 is provided downstream of the base loading mechanism 20 in a rotation direction of the material carrying rotary table 11, the support installation mechanism 30 includes a support material tray 31 which is provided on the base 10, a support material channel 32 which is connected to the support material tray 31, and a support assembly mechanical arm 33. A vibrator is provided on a base of the support material tray 31 to vibrate the support material tray 31, so as to smoothly flow a support to the support material channel 32. The support assembly mechanical arm 33 is connected to a mechanical arm support, an end of the mechanical arm support is fixed to the base 10, and another end of the mechanical arm support is fixed to the installation disc 12, which can further fix the installation disc 12. The swing rod installation mechanism 40 is provided downstream of the support installation mechanism 30 in the direction of rotation of the material carrying rotary table 11, the swing rod installation mechanism 40 includes a swing rod material reel 41, a swing rod material channel 42, and a swing rod assembly mechanical arm 43. The swing rod material reel 41 has a second material reel supporting frame, and an end of a bottom frame of the second material reel supporting frame is fixed on the base 10. A tension spring installation mechanism 50 is provided downstream of the swing rod installation mechanism 40 in the rotation direction of the material carrying rotary table 11, the tension spring installation mechanism 50 includes a tension spring pre-installation platform 51, a tension spring position detection platform 52, a tension spring installation platform 53, and a tension spring elasticity detection platform 54 that are sequentially provided along the direction of rotation of the material carrying rotary table 11.

Referring to FIG. 1, the microswitch automatic assembly apparatus further includes an opening and closing dimensions detecting platform 60, a material separation detecting platform 70, and a material unloading channel 90, that are sequentially provided downstream of the tension spring elasticity detection platform 54 along the rotation direction of the material carrying rotary table 11, the opening and closing dimensions detecting platform 60 is configured to detect opening and closing dimensions between contacts, and the material separation detecting platform 70 detects a performance of workpieces. A waste pipeline is further provided on a side of the material unloading channel 90, a material unloading mechanical arm transfers finished products to the material unloading channel 90 and transfers wastes to the waste pipeline.

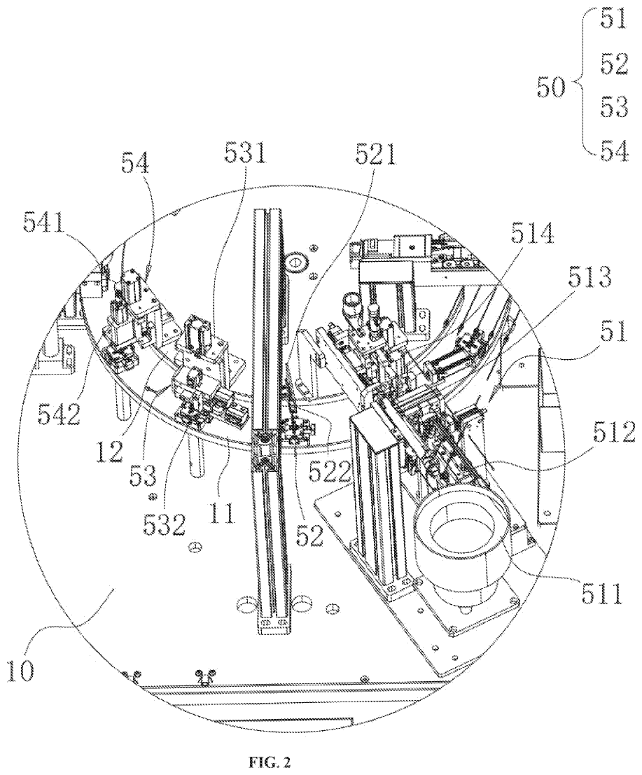

Referring to FIG. 2, the tension spring pre-installation platform 51 includes a tension spring material tray 511 which is provided on the installation disc 12, a tension spring material channel 512 which is connected to an end of the tension spring material tray 511, a tension spring correction mechanical arm 513, and a tension spring pre-installation mechanical arm 514. The vibrator is provided on a base of the tension spring material tray 511 to vibrate the tension spring material tray 511, so as to smoothly flow the tension spring to the tension spring material channel 512. The tension spring pre-installation mechanical arm 514 is connected to the mechanical arm support, the end of the mechanical arm support is fixed to the base 10, and the other end of the mechanical arm support is fixed to the installation disc 12, which can further fix the installation disc 12.

The tension spring position detection platform 52 includes a first support 521 which is fixed on the installation disc 12 and a position detector 522 which is provided on the first support 521 for detecting a position of a pre-installed tension spring; the tension spring installation platform 53 includes a second support 531 which is fixed on the installation disc 12 and a mechanical pulling claw 532 which is connected to the second support 531 and capable of moving up and down for stretching the tension spring; the tension spring elasticity detection platform 54 includes a third support 541 which is fixed on the installation disc 12 and a compression bar 542 which is provided on the third support 541 for detecting an installation position of the tension spring.

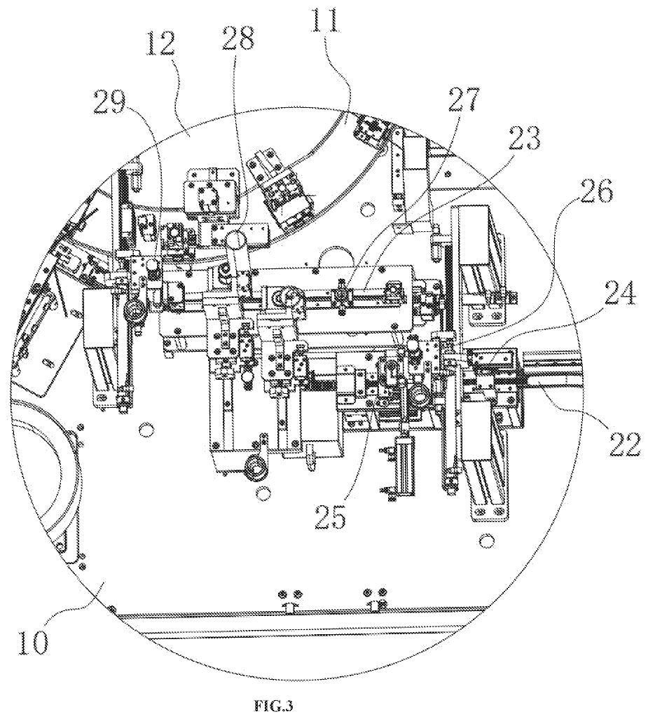

Referring to FIG. 3, a base detector 24, a base cutter 25, and a first transfer mechanical arm 26 are sequentially provided above the first material channel 22, the base detector 24 is provided directly above the first material channel 22 through the support. A rear end of the first material channel 22 is further provided with a waste collecting bucket, an unqualified base which is detected by the base detector 24 flows to the waste collecting bucket, the base detector 24 is configured to detect whether there is material on a base material belt and detect an appearance and a dimension of the base, the base cutter 25 is configured to cut a base chain into a single base, and the first transfer mechanical arm 26 is configured to transfer the base to the second material channel 23.

A blowing and suction device 27, an oil dispenser 28, and a second transfer mechanical arm 29 are sequentially provided above the second material channel 23, the blowing and suction device 27 is configured to remove impurities from the base, the oil dispenser 28 is configured to apply oil to the base to improve a lubricity and corrosion resistance of a base surface, and the second transfer mechanical arm 29 is configured to transfer the base to the workpiece carriers 13.

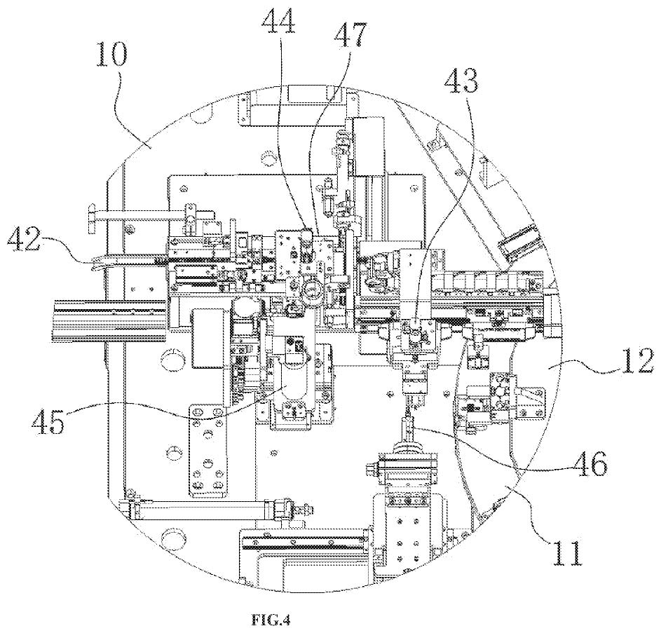

Referring to FIG. 4, the swing rod installation mechanism 40 further includes a swing rod cutter 47, a swing rod transfer mechanical arm 44, and a swing rod detector 45 that are provided downstream of the swing rod material channel 42, the swing rod transfer mechanical arm 44 is configured to transfer a swing rod on the swing rod material channel 42 to the swing rod detector 45 for the swing rod detector 45 to detect opening and closing dimensions of the swing rod.

The swing rod installation mechanism 40 further includes a swing rod correction mechanical arm 46, which is provided between the swing rod detector 45 and the swing rod assembly mechanical arm 43 for correcting a direction of the swing rod.

The implementation principle of the microswitch automatic assembly apparatus in the embodiment of the present application is: providing the base chain formed by connecting a single switch base, loading the base chain onto the first material channel 22, the conveyor belts on the first material channel 22 drives the base chain to move forward, passing through the base detector 24 and moving to the base cutter 25, the base cutter 25 cuts and detects a qualified base, the unqualified base is transferred to the waste collecting bucket. The first transfer mechanical arm 26 transfers the qualified base to the second material channel 23, the second material channel 23 blows air to clean and oil the base sequentially, then, it is transferred to the material carrying rotary table 11 through the second transfer mechanical arm 29, the material carrying rotary table 11 is transferred to the support installation mechanism 30, and the support is installed on the support installation mechanism 30. A base of an installing support is transferred to the swing rod installation mechanism 40 through the material carrying rotary table 11, and the swing rod is provided on the swing rod installation mechanism 40. A base for installing the swing rod is transferred to the tension spring installation mechanism 50 through the material carrying rotary table 11, and the tension spring is provided on the tension spring installation mechanism 50. After installing the tension spring, the opening and closing dimensions are detected by the opening and closing dimensions detecting platform 60, and appearance dimensions are detected by the material separation detecting platform 70, the material unloading mechanical arm transfers finished products to the material unloading channel 90 and transfers wastes to the waste pipeline.

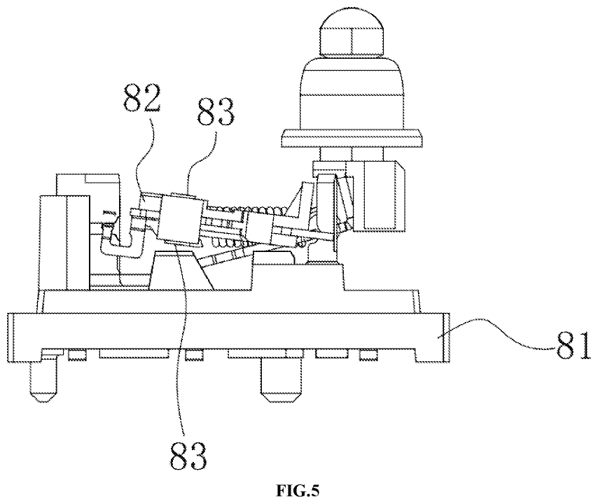

Referring to FIG. 5, the embodiment of the present application provides the microswitch, which adopts the microswitch automatic assembly apparatus as described in any one of the above items, the microswitch includes a microswitch base 81, an action spring plate assembly 82, and a silencing gasket 83, the silencing gasket 83 is provided on an upper surface and a lower surface of the action spring plate assembly 82 to eliminate a noise generated when the action spring plate assembly 82 collides with an upper cover and the microswitch base 81.

The implementation principle of the microswitch in the embodiment of the present application: when developing the microswitch, the action spring plate assembly 82 of the microswitch collides with the microswitch base 81 and generates noise; when the microswitch is turned off, the action spring plate assembly 82 of the microswitch collides with the upper cover and generates noise. The silencing gasket 83 is provided on the upper and lower surfaces of the action spring plate assembly 82 to reduce the noise generated when the microswitch is turned on and turned off.

Referring to FIG. 1, the embodiment of the present application provides the assembly method for the microswitch, which adopts the microswitch automatic assembly apparatus as described in any one of the above items, the assembly method includes: S1. providing switch bases, the switch bases are provided on base frames, the base frames are connected to each other, and forming a base chain; S2. transferring the base chain to the first material channel 22, and then transferring the base chain to the material carrying rotary table 11 through the first material channel 22 and the second material channel 23; S3. when the material carrying rotary table 11 transfers the base to the support installation mechanism 30, the support assembly mechanical arm 33 grabs the support and installs it onto the base; S4. when the material carrying rotary table 11 transfers a base of an installed support to the swing rod installation mechanism 40, the swing rod assembly mechanical arm 43 grabs the swing rod and installs it on the base; S5. When the material carrying rotary table 11 transfers a base of an installed swing rod to the tension spring installation mechanism 50, the tension spring installation mechanism 50 performs a pre-installation, position detection, installation, and installation detection on the tension spring.

The implementation principle of the assembly method for the microswitch in the present embodiment is: after passing a detection, the switch base is transferred to the material carrying rotary table 11, which drives the base, installing the support on the support installation mechanism 30, installing the swing rod on the swing rod installation mechanism 40, the tension spring installation mechanism 50 is pre-installed with the tension spring, and performing position detection after pre-installation to ensure an accuracy of a relative position between the tension spring and the switch base, improving an accuracy of installing the tension spring during assembly, thereby increasing a yield rate of microswitch production.

The above are the preferred embodiments of the present application, which are not intended to limit the protection scope of the present application. Therefore, all equivalent changes made according to the structure, shape and principle of the present application should be covered within the protection scope of the present application.

### LIST OF REFERENCE SIGNS

10 base
11 material carrying rotary table
12 installation disc
13 workpiece carriers
20 base loading mechanism
21 base material reel
22 first material channel
23 second material channel
24 base detector
25 base cutter
26 first transfer mechanical arm
27 blowing and suction device
28 oil dispenser
29 second transfer mechanical arm
30 support installation mechanism
31 support material tray
32 support material channel
33 support assembly mechanical arm
40 swing rod installation mechanism
41 swing rod material reel
42 swing rod material channel
43 swing rod assembly mechanical arm
44 swing rod transfer mechanical arm
45 swing rod detector
46 swing rod correction mechanical arm
47 swing rod cutter
50 tension spring installation mechanism
51 tension spring pre-installation platform
511 tension spring material tray
512 tension spring material channel
513 tension spring correction mechanical arm
514 tension spring pre-installation mechanical arm
52 tension spring position detection platform
521 first support
522 position detector
53 tension spring installation platform
531 second support
532 mechanical pulling claw
54 tension spring elasticity detection platform
541 third support
542 compression bar
60 opening and closing dimensions detection platform
70 material separation detection platform
81 microswitch base
82 action spring plate assembly
83 silencing gasket
90 material unloading channel

What is claimed is:

1. A microswitch automatic assembly apparatus, comprising:
a base, wherein the base is provided with a material carrying rotary table, an installation disc is provided on the material carrying rotary table, and a plurality of workpiece carriers are provided at equal intervals on a periphery of the material carrying rotary table;
a base loading mechanism that is arranged on the base, wherein the base loading mechanism comprises a base material reel, a first material channel, and a second material channel that is arranged on a side of the first material channel;
a support installation mechanism, wherein the support installation mechanism is provided downstream of the base loading mechanism along a rotation direction of the material carrying rotary table, the support installation mechanism comprises a support material tray that is provided on the base, a support material channel that is connected to the support material tray, and a support assembly mechanical arm;
a swing rod installation mechanism, wherein the swing rod installation mechanism is provided downstream of the support installation mechanism along the rotation direction of the material carrying rotary table, and the swing rod installation mechanism comprises a swing rod material reel, a swing rod material channel, and a swing rod assembly mechanical arm; and
a tension spring installation mechanism, wherein the tension spring installation mechanism is provided downstream of the swing rod installation mechanism along the rotation direction of the material carrying rotary table, the tension spring installation mechanism comprises a tension spring pre-installation platform, a tension spring position detection platform, a tension spring installation platform, and a tension spring elasticity detection platform, which are sequentially provided along the rotation direction of the material carrying rotary table.

2. The microswitch automatic assembly apparatus according to claim 1, wherein the tension spring pre-installation platform comprises a tension spring material tray that is provided on the installation disc, a tension spring material channel with one end connected to the tension spring material tray, a tension spring correction mechanical arm, and a tension spring pre-installation mechanical arm.

3. The microswitch automatic assembly apparatus according to claim 1, wherein the tension spring position detection platform comprises a first support that is fixed on the installation disc and a position detector that is provided on the first support for detecting a pre-installed position of a tension spring, the tension spring installation platform comprises a second support that is fixed on the installation disc and a mechanical pulling claw that is connected to the second support and configured to move up and down for stretching the tension spring, and the tension spring elasticity detection platform comprises a third support that is fixed on the installation disc and a compression bar that is provided on the third support for detecting an installation position of the tension spring.

4. The microswitch automatic assembly apparatus according to claim 1, wherein a base detector, a base cutter, and a first transfer mechanical arm are sequentially provided above the first material channel, the base detector is configured to detect whether there is material on a base material belt and detect an appearance and a dimension of the base, the base cutter is configured to cut a base chain into a single base, and the first transfer mechanical arm is configured to transfer the base to the second material channel.

5. The microswitch automatic assembly apparatus according to claim 1, wherein a blowing and suction device, an oil dispenser, and a second transfer mechanical arm are sequentially provided above the second material channel, the blowing and suction device is configured to remove impurities from the base, the oil dispenser is configured to apply oil to the base to improve a lubricity and corrosion resistance of a surface of the base, and the second transfer mechanical arm is configured to transfer the base to the plurality of workpiece carriers.

6. The microswitch automatic assembly apparatus according to claim 1, wherein the swing rod installation mechanism further comprises a swing rod cutter, a swing rod transfer mechanical arm, and a swing rod detector that are provided downstream of the swing rod material channel, and the swing rod transfer mechanical arm is configured to transfer a swing rod on the swing rod material channel to the swing rod detector for the swing rod detector to detect opening and closing dimensions of the swing rod.

7. The microswitch automatic assembly apparatus according to claim 6, wherein the swing rod installation mechanism further comprises a swing rod correction mechanical arm that is provided between the swing rod detector and the swing rod assembly mechanical arm for correcting a direction of the swing rod.

8. The microswitch automatic assembly apparatus according to claim 1, further comprising an opening and closing dimensions detection platform, a material separation detection platform, and a material unloading channel that are sequentially provided downstream of the tension spring elasticity detection platform along the rotation direction of the material carrying rotary table, the opening and closing dimensions detection platform is configured to detect opening and closing dimensions between contacts, and the material separation detection platform is configured to detect performance of workpieces.
